(19) United States
(12) Patent Application Publication
(10) Pub. No.: US 2025/0196065 A1
(43) Pub. Date: Jun. 19, 2025

(54) GAS REMEDIATION DEVICE

(71) Applicant: INDUSTRIAL TECHNOLOGY RESEARCH INSTITUTE, Hsinchu (TW)

(72) Inventors: Kuo-Ching WU, Hsinchu City (TW); Pao-Tsern LIN, Zhubei City (TW); Chiung-Hui HUANG, Hsinchu (TW)

(73) Assignee: INDUSTRIAL TECHNOLOGY RESEARCH INSTITUTE, Hsinchu (TW)

(21) Appl. No.: 18/678,128

(22) Filed: May 30, 2024

(30) Foreign Application Priority Data
Dec. 13, 2023 (TW) 112148428

(51) Int. Cl. B01D 53/86; B01D 51/10; B01D 53/56

(52) U.S. Cl. CPC B01D 53/8631; B01D 51/10; B01D 53/56; B01D 53/8628; B01D 2255/2065; B01D 2255/2073; B01D 2255/20746; B01D 2257/404; B01D 2258/0283

(57) ABSTRACT

A gas remediation device is provided, which includes an air inlet, a dust filter component, a conversion component, a scrubber component, and an air outlet. The air inlet is used to receive flue gas, wherein the flue gas includes nitrogen monoxide. The dust filter component is in fluid communication with the air inlet. The conversion component is in fluid communication with the dust filter component. The conversion component includes a conversion chamber, and the conversion chamber includes a conversion catalyst. The conversion catalyst converts nitrogen monoxide into nitrogen, oxygen, nitrogen dioxide, or a combination thereof at an operating temperature of 15° C. to 300° C. The scrubber component is in fluid communication with the conversion component. The air outlet is in fluid communication with the scrubber component.

### CROSS REFERENCE TO RELATED APPLICATIONS

This application claims priority of Taiwan Patent Application No. 112148428, filed on Dec. 13, 2023, the entirety of which is incorporated by reference herein.

### BACKGROUND OF THE INVENTION

### Field of the Invention

The present disclosure relates to gas remediation technology, and, in particular, to a gas remediation device for converting nitrogen monoxide.

### Description of the Related Art

With the rise of environmental awareness, the treatment of industrial pollutants has become increasingly important. For example, in a general large-scale factory system, a large number of devices such as boilers, furnaces, and steam equipment are usually used as power sources for production or processing. These devices discharge the burned exhaust gas into the atmosphere through a flue, so the burned exhaust gas can also be called flue gas. Generally speaking, the compositions of flue gas include nitrogen oxides (NOx) such as nitrogen monoxide (NO), wherein the dangers of nitrogen monoxide include but are not limited to being fatal if inhaled, causing severe burns, causing eye damage, and being corrosive to respiratory tract. Therefore, gas remediation devices are needed to reduce the emissions of nitrogen monoxide.

For the aforementioned purpose, prior art has used some conversion catalysts to convert nitrogen monoxide into other gases that are less toxic or non-toxic (e.g., nitrogen, oxygen, and nitrogen dioxide). However, these conversion catalysts may need to be operated with an amino reducing agent or may have to operate at high temperatures, which is not conducive to reducing pollution and energy consumption. Therefore, how to provide a gas remediation device that can operate at low temperatures and does not contain an amino reducing agent has become an urgent issue in the art.

### BRIEF SUMMARY OF THE INVENTION

In some embodiments of the present disclosure, a gas remediation device is provided. The gas remediation device includes an air inlet, a dust filter component, a conversion component, a scrubber component, and an air outlet. The air inlet is used to receive flue gas, wherein the flue gas includes nitrogen monoxide. The dust filter component is in fluid communication with the air inlet. The conversion component is in fluid communication with the dust filter component. The conversion component includes a conversion chamber, and the conversion chamber includes a conversion catalyst. The conversion catalyst converts nitrogen monoxide into nitrogen, oxygen, nitrogen dioxide, or a combination thereof at an operating temperature of 15° C. to 300° C. The scrubber component is in fluid communication with the conversion component. The air outlet is in fluid communication with the scrubber component.

The gas remediation device of the present disclosure can be applied in a variety of production equipment or processing equipment. In order to make the features and advantages of the present disclosure more comprehensible, various embodiments are specially cited below, together with the accompanying drawings, to be described in detail as follows.

### BRIEF DESCRIPTION OF THE DRAWINGS

Aspects of the present disclosure are best understood from the following detailed description when read with the accompanying figures. It should be noted that, in accordance with the standard practice in the industry, various features are not drawn to scale. In fact, the dimensions of the various features may be arbitrarily increased or reduced for clarity of discussion.

FIG. 1 is a block diagram showing the gas remediation device according to some embodiments of the present disclosure.

FIG. 2 is a three-dimensional schematic diagram showing the conversion chamber according to some embodiments of the present disclosure.

FIG. 3 is a schematic top view showing the conversion chamber according to some embodiments of the present disclosure.

FIG. 4 is a three-dimensional schematic diagram showing the conversion chamber according to other embodiments of the present disclosure.

FIG. 5 is a three-dimensional schematic diagram showing the conversion chamber according to some further embodiments of the present disclosure.

### DETAILED DESCRIPTION OF THE INVENTION

The following disclosure provides many different embodiments or examples for implementing the various features of the provided device. Specific examples of features and their configurations are described below to simplify the embodiments of the present disclosure, but certainly not to limit the present disclosure. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

The directional terms mentioned herein, such as “up”, “down”, “left”, “right”, and similar terms refer to the directions of the drawings. Accordingly, the directional terms used is to illustrate, not to limit, the present disclosure.

In some embodiments of the present disclosure, terms about disposing and connecting, such as “disposing”, “connecting” and similar terms, unless otherwise specified, may refer to two features are in direct contact with each other, or may also refer to two features are not in direct contact with each other, wherein there is an additional connect feature between the two features. The terms about disposing and connecting may also include the case where both features are movable, or both features are fixed.

In addition, ordinal numbers such as “first”, “second”, and the like used in the specification and claims are configured to modify different features or to distinguish different embodiments or ranges, rather than to limit the number, the upper or lower limits of features, and are not intended to limit the order of manufacture or arrangement of features.

Herein, the terms “approximately”, “about”, and “substantially” generally mean within 10%, within 5%, within 3%, within 2%, within 1%, or within 0.5% of a given value or range. The given value is an approximate value, that is, “approximately”, “about”, and “substantially” can still be implied without the specific description of “approximately”, “about”, and “substantially”.

Unless otherwise defined, all terms (including technical and scientific terms) used herein have the same meaning as commonly understood by one of ordinary skill in the art. It should be understood that these terms, such as those defined in commonly used dictionaries, should be interpreted as having meanings consistent with the background or context of the related technology and the present disclosure, and should not be interpreted in an idealized or overly formal manner, unless otherwise specified in the embodiments of the present disclosure.

Some variations of the embodiments are described below. In different figures and described embodiments, the same or similar reference numerals are configured to refer to the same or similar features. It should be understood that additional steps may be provided before, during, and after the method, and that some described steps may be replaced or deleted for another embodiment of the method.

In the prior art, the flue gas is usually treated by heating the flue gas, or using an amino reducing agent with a conversion catalyst to convert nitrogen monoxide into oxygen, nitrogen, nitrogen dioxide, or a combination thereof. This approach may not be conducive to reducing environmental pollution or reducing energy consumption. Therefore, the present disclosure provides a gas remediation device that can operate at low temperature and does not contain an amino reducing agent to solve at least some of the above problems.

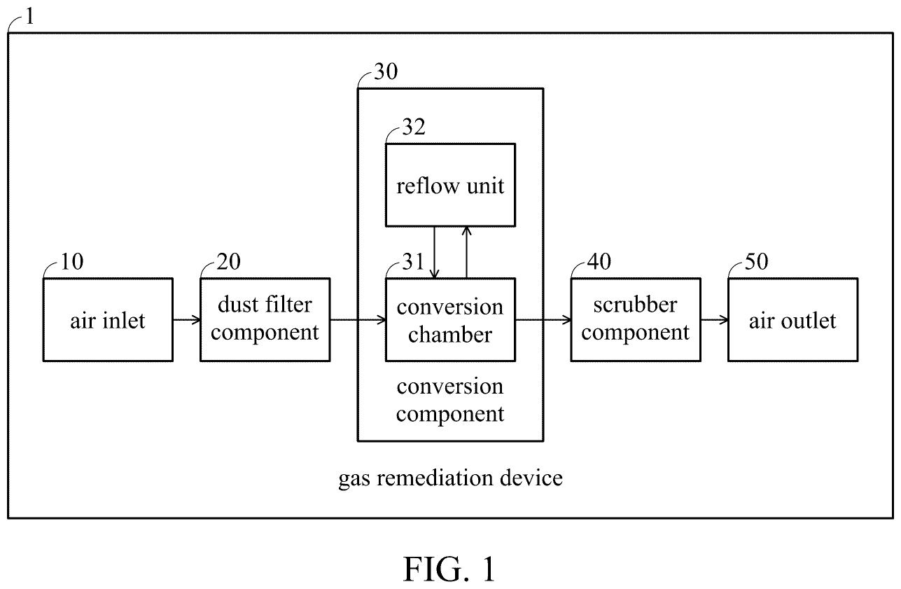

FIGS. 1 to 3 respectively show a block diagram of the gas remediation device, a three-dimensional schematic diagram of the conversion chamber, and a schematic top view of the conversion chamber according to some embodiments of the present disclosure. In some embodiments, the gas remediation device 1 may be disposed at, for example, the end of a flue of a boiler device, to remediate the flue gas in the flue. More specifically, the gas remediation device 1 of the present disclosure is used to remediate nitrogen monoxide of flue gas. For example, to reduce the environmental pollution caused by untreated flue gas, the gas remediation device 1 may convert nitrogen monoxide into nitrogen, oxygen, nitrogen dioxide, or a combination thereof. As shown in FIG. 1, the gas remediation device 1 includes an air inlet 10, a dust filter component 20, a conversion component 30, a scrubber component 40, and an air outlet 50.

As shown in FIG. 1, the air inlet 10 is used to receive flue gas, wherein the flue gas includes nitrogen monoxide. For example, the air inlet 10 may be in fluid communication with, for example, a flue of a boiler device, to receive freshly discharged flue gas, wherein the flue gas may include nitrogen monoxide and other nitrogen oxides. However, the present disclosure is not limited thereto. In some embodiments, the air inlet 10 may also be in fluid communication with other gas remediation devices to receive flue gas from other gas remediation devices.

In some embodiments, the temperature of the flue gas received may be between 15° C. and 300° C. For example, the temperature of the flue gas may be 15° C., 30° C., 90° C., 150° C., 200° C., 250° C., 300° C., or any value or range between the above values. However, the present disclosure is not limited thereto. In other embodiments, the temperature of the flue gas received may be slightly above 300° C., such as 330° C., 350° C., etc.

As shown in FIG. 1, the dust filter component 20 is in fluid communication with the air inlet 10 to receive the flue gas entering from the air inlet 10. Specifically, the dust filter component 20 is used to filter large suspended particles in the flue gas. In some embodiments, the material of the dust filter component 20 may be or may include aluminum oxide (Al₂O₃) fiber, polytetrafluoroethylene (PTFE) fiber, polyimide (PI) fiber, aramid fiber, polyphenylene sulfide (PPS) fiber, other suitable materials, or a combination thereof, but the present disclosure is not limited thereto. In some embodiments, the dust filter component 20 may include a filter screen with high porosity. For example, the dust filter component 20 may include an aluminum oxide filter with a density of about 0.4 g/cm³ and a diameter of about 2 μm to 3 μm to filter out dust with a particle size of 100 nm to 1000 nm.

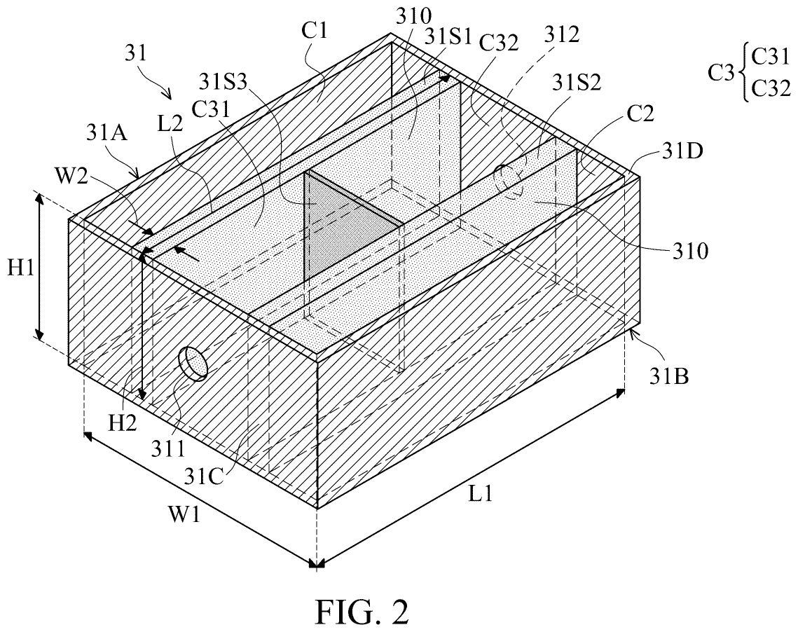

As shown in FIGS. 1 and 2, the conversion component 30 is in fluid communication with the dust filter component 20. The conversion component 30 includes a conversion chamber 31, and the conversion chamber 31 includes a conversion catalyst 310. The conversion catalyst 310 converts nitrogen monoxide into nitrogen, oxygen, nitrogen dioxide, or a combination thereof at an operating temperature of 15° C. to 300° C. In some embodiments, the chemical reaction equation between nitrogen monoxide and nitrogen, oxygen, and nitrogen dioxide may be shown as the reaction equation 1 and reaction equation 2, but the present disclosure is not limited thereto.

NO+NO→N₂+O₂ Reaction equation 1:

2NO+O₂→NO₂ Reaction equation 2:

It should be noted that the conversion component 30 of the present disclosure may realize the above-mentioned reaction equation 1 and reaction equation 2 only through the conversion catalyst 310 without using an amino reducing agent. In some embodiments, when the temperature of the flue gas is between 15° C. and 300° C., the present disclosure may directly process the flue gas through the conversion catalyst 310 without heating the flue gas. In other words, the conversion component 30 of the present disclosure may process the flue gas without ammonia and process the flue gas at low temperature, thereby achieving more environmentally friendly and low energy consumption gas remediation. In some embodiments, the conversion catalyst has a chemical structure as MnM1ₓM2_{y}O_{z}, wherein M1 is La, Ce, Fe, or a combination thereof, M2 is Cu, Co, Ni, or a combination thereof, x is between 0.1 and 1, y is between 0.05 and 0.8, z is stoichiometric, and x>y. For example, the conversion catalyst 310 may be or may include MnCe_{0.3}Co_{0.3}O_{z}, but the present disclosure is not limited thereto.

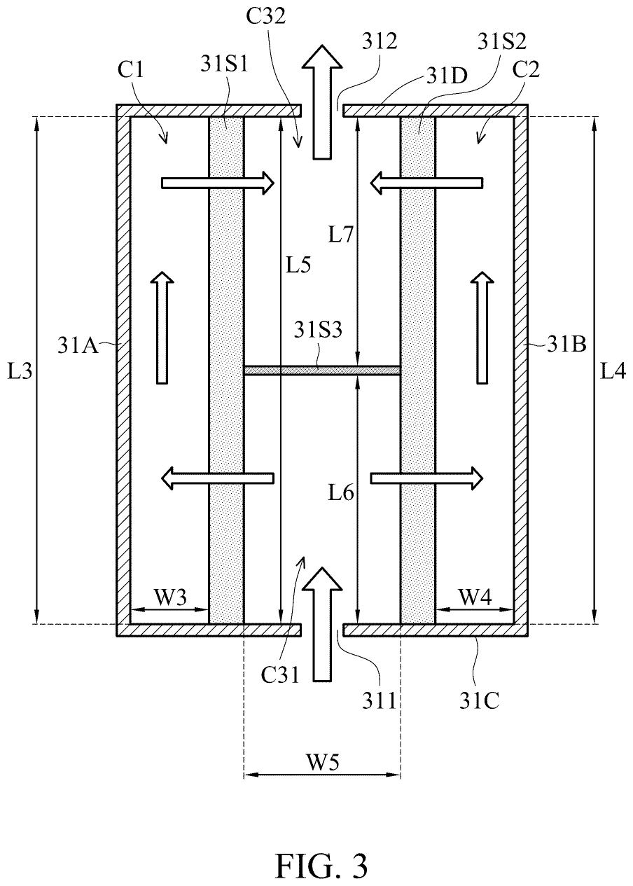

In some embodiments, the conversion catalysts 310 in the conversion chamber 31 are arranged in a specific manner to achieve gas conversion with higher efficiency under the same volume or weight. As shown in FIGS. 2 and 3, the conversion chamber 31 has a first sidewall 31A and a second sidewall 31B that are opposite to each other, and the conversion chamber 31 further has a third sidewall 31C and a fourth sidewall 31D between the first sidewall 31A and the second sidewall 31B. It should be noted that, for ease of understanding, the upper wall (or upper cover) of the conversion chamber 31 is omitted in FIG. 2. In some embodiments, the first sidewall 31A is orthogonal to the third sidewall 31C and the fourth sidewall 31D, and the second sidewall 31B is orthogonal to the third sidewall 31C and the fourth sidewall 31D. In other words, the conversion chamber 31 is a rectangular cavity, but the present disclosure is not limited thereto. It should be noted that the term “orthogonal” as used above may include slight angular tolerances. For example, there is an included angle of 85 degrees to 95 degrees between the first sidewall 31A and the third sidewall 31C or the fourth sidewall 31D, or there is an included angle of 85 degrees to 95 degrees between the second sidewall 31B and the third sidewall 31C or the fourth sidewall 31D.

As shown in FIGS. 2 and 3, in some embodiments, the conversion chamber 31 includes a first catalyst structure 31S1, a second catalyst structure 31S2, a barrier structure 31S3, a chamber air inlet 311, and a chamber air outlet 312. Among them, the first catalyst structure 31S1, the second catalyst structure 31S2, and the barrier structure 31S3 are arranged in an “H shape” (as shown in FIG. 3). Specifically, the first catalyst structure 31S1 is adjacent to the first sidewall 31A and extends along the first sidewall 31A, wherein the first catalyst structure is filled with the conversion catalyst 310, and a first flow channel C1 is formed between the first catalyst structure 31S1 and the first sidewall 31A. The second catalyst structure 31S2 is adjacent to the second sidewall 31B and extends along the second sidewall 31B, wherein the second catalyst structure 31S2 is filled with the conversion catalyst 310, a second flow channel C2 is formed between the second catalyst structure 31S2 and the second sidewall 31B, and a third flow channel C3 is formed between the second catalyst structure 31S2 and the first catalyst structure 31S1. The above-mentioned first flow channel C1, second flow channel C2, and third flow channel C3 are used for passing through the flue gas.

The first catalyst structure 31S1 and the second catalyst structure 31S2 have porous structures, and the pores are large enough to allow the flue gas to pass through. In this way, when the flue gas passes through the pores of the first catalyst structure 31S1 and the second catalyst structure 31S2, the conversion catalyst 310 in the first catalyst structure 31S1 and the second catalyst structure 31S2 may convert the nitrogen monoxide of the flue gas into oxygen, nitrogen, nitrogen dioxide, or a combination thereof.

The barrier structure 31S3 is disposed between the first catalyst structure 31S1 and the second catalyst structure 31S2 and has no pores. Under this circumstance, when the flue gas cannot pass through the barrier structure 31S3, the barrier structure 31S3 may split the third flow channel C3 into a first sub flow channel C31 and a second sub flow channel C32. In this case, the chamber air inlet 311 is disposed on the third sidewall 31C and is in fluid communication with the first sub flow channel C31. The chamber air outlet 312 is disposed on the fourth sidewall 31D and is in fluid communication with the second sub flow channel C32.

In this case, the flow of the flue gas may be as shown in FIG. 3. Specifically, the flue gas enters the first sub flow channel C31 of the third flow channel C3 through the chamber air inlet 311. After being blocked by the barrier structure 31S3, the flue gas passes through the first catalyst structure 31S1 and enters the first flow channel C1, and passes through the second catalyst structure 31S2 and enters the second flow channel C2. Then, the flue gas enters the second sub flow channel C32 of the third flow channel C3 through the first catalyst structure 31S1 and the second catalyst structure 31S2. Finally, after passing through the conversion catalyst 310 (located in the first catalyst structure 31S1 and the second catalyst structure 31S2) several times (e.g., at least twice as described above), the converted flue gas leaves the conversion chamber 31 from the chamber air outlet. 312. This arrangement has excellent conversion efficiency and may have low pressure drop. Therefore, the conversion efficiency of nitrogen monoxide may be further improved through the above arrangement.

In some embodiments, a length L1 of the inner wall of the conversion chamber 31 (i.e., excluding the thickness of the conversion chamber 31) may be between 50 cm and 150 cm, but the present disclosure is not limited thereto. For example, the length L1 of the inner wall of the conversion chamber 31 may be 50 cm, 70 cm, 90 cm, 110 cm, 130 cm, 150 cm, or any value or range between the above values. In some embodiments, a width W1 of the inner wall of the conversion chamber 31 may be between 25 cm and 75 cm, but the present disclosure is not limited thereto. For example, the width W1 of the inner wall of the conversion chamber 31 may be 25 cm, 35 cm, 45 cm, 55 cm, 65 cm, 75 cm, or any value or range between the above values, but the present disclosure is not limited thereto. In some embodiments, a height H1 of the inner wall of the conversion chamber 31 may be between 50 cm and 150 cm, but the present disclosure is not limited thereto. For example, the height H1 of the inner wall of the conversion chamber 31 may be 50 cm, 70 cm, 90 cm, 110 cm, 130 cm, 150 cm, or any value or range between the above values. In some embodiments, the length L1 of the inner wall of the conversion chamber 31 may be the same as the height H1, and the width W1 may be half of the length L1 or the height H1, but the present disclosure is not limited thereto.

In some embodiments, a length L2 of the first catalyst structure 31S1 may be between 50 cm and 150 cm, but the present disclosure is not limited thereto. For example, the length L2 of the first catalyst structure 31S1 may be 50 cm, 70 cm, 90 cm, 110 cm, 130 cm, 150 cm, or any value or range between the above values. In some embodiments, the first catalyst structure 31S1 may fill up the conversion chamber 31 in the length direction. In some embodiments, a width W2 of the first catalyst structure 31S1 may be between 4 cm and 16 cm, but the present disclosure is not limited thereto. For example, the width W2 of the first catalyst structure 31S1 may be 4 cm, 6 cm, 8 cm, 10 cm, 12 cm, 14 cm, 16 cm, or any value or range between the above values. In some embodiments, a height H2 of the first catalyst structure 31S1 may be between 50 cm and 150 cm, but the present disclosure is not limited thereto. For example, the height H2 of the first catalyst structure 31S1 may be 50 cm, 70 cm, 90 cm, 110 cm, 130 cm, 150 cm, or any value or range between the above values. In some embodiments, the first catalyst structure 31S1 may fill up the conversion chamber 31 in the height direction.

In some embodiments, the size of the second catalyst structure 31S2 may be similar to or the same as the first catalyst structure 31S1. For example, the length, width, and height of the second catalyst structure 31S2 may be similar to or the same as the length L2, width W2, and height H2 of the first catalyst structure 31S1, respectively. However, the present disclosure is not limited thereto. For example, the width of the second catalyst structure 31S2 may be greater or smaller than the width W2 of the first catalyst structure 31S1.

In some embodiments, the first catalyst structure 31S1 has a first volume, the second catalyst structure 31S2 has a second volume, and the sum of the first volume and the second volume occupies between 20% and 40% of the volume of the conversion chamber 31. In other words, the remaining volume of the conversion chamber 31 is taken up by the first flow channel C1, the second flow channel C2, the third flow channel C3, and the barrier structure 31S3. For example, the sum of the first volume and the second volume occupies 20%, 25%, 30%, 35%, or 40% of the volume of the conversion chamber 31, or any value or range between the above values, but the present disclosure is not limited thereto.

As shown in FIG. 3, in some embodiments, the first flow channel C1 has a first width W3, the second flow channel C2 has a second width W4, the third flow channel C3 has a third width W5, and the third width W5 is equal to the sum of the first width W3 and the second width W4. In some embodiments, the first width W3 of the first flow channel C1 may be between 3.5 cm and 13.5 cm, such as 3.5 cm, 6.0 cm, 8.5 cm, 11 cm, 13.5 cm, or any value or range between the above values, but the present disclosure is not limited thereto. In some embodiments, the second width W4 of the second flow channel C2 may be between 3.5 cm and 13.5 cm, such as 3.5 cm, 6.0 cm, 8.5 cm, 11 cm, 13.5 cm, or any value or range between the above values, but the present disclosure is not limited thereto. In some embodiments, the third width W5 of the third flow channel C3 may be between 7 cm and 27 cm, such as 7 cm, 12 cm, 17 cm, 22 cm, 27 cm, or any value or range between the above values, but the present disclosure is not limited thereto. In some embodiments, the first width W3 may be the same as the second width W4, but the present disclosure is not limited thereto.

In some embodiments, the first flow channel C1 has a length L3, the second flow channel C2 has a length L4, the third flow channel C3 has a length L5, and the lengths L3, L4 and L5 are equal to each other. In some embodiments, the length L3, the length L4, and the length L5 may be between 50 cm and 150 cm, such as 50 cm, 75 cm, 90 cm, 105 cm, 120 cm, 135 cm, 150 cm, or any value or range between the above values, but the present disclosure is not limited thereto.

In some embodiments, the barrier structure 31S3 may be a baffle, and the baffle is used to block the passage of flue gas. In some embodiments, the first sub flow channel C31 of the third flow channel C3 separated by the baffle has a first length L6, and the second sub flow channel C32 has a second length L7, and the first length L6 is the same as the second length L7. In other words, in these embodiments, the barrier structure 31S3 may be disposed in the middle of the third flow channel C3. However, the present disclosure is not limited thereto. In other embodiments, the barrier structure 31S3 may also be disposed on a side adjacent to the third sidewall 31C or a side adjacent to the fourth sidewall 31D.

In the above, some possible dimensions or possible shapes of the conversion chamber 31 have been described. It should be noted that although specific dimensions (e.g., centimeters) are used to express each component and the relationship between them, the present disclosure may adjust the size of the conversion chamber 31 as needed. For example, the specific numerical values of each above-mentioned component may be enlarged or reduced in equal proportions and applied to gas remediation devices 1 of different sizes. For example, the ratio of length L1 to width W1 to height H1 of the conversion chamber 31 may be 2:1:2. Alternatively, the ratio of length L2 to width W2 to height H2 of the first catalyst structure 31S1 may be 100:8:100; or the ratio of length to width to height of the second catalyst structure 31S2 may be 100:8:100.

In some embodiments, based on the above configuration (i.e., the H-shaped catalyst as described above), the pressure drop of the flue gas after passing through the conversion chamber 31 may be between 50 Pa and 850 Pa. For example, the pressure drop of the flue gas after passing through the conversion chamber 31 may be 50 Pa, 100 Pa, 150 Pa, 300 Pa, 400 Pa, 500 Pa, 600 Pa, 700 Pa, 800 Pa, 850 Pa, or any value or range between the above values, but the present disclosure is not limited thereto. In other words, the structure of the conversion chamber 31 disclosed in the present disclosure may have excellent flow diversion effect, thereby processing the conversion of nitrogen monoxide more effectively.

Alternatively, the unit of pressure drop may also be expressed in mmAq. In some embodiments where the pressure drop is expressed in mmAq, the pressure drop of the flue gas may be between 5 mmAq and 85 mmAq. For example, the pressure drop of the flue gas after passing through the conversion chamber 31 may be 5 mmAq, 10 mmAq, 15 mmAq, 30 mmAq, 40 mmAq, 50 mmAq, 60 mmAq, 70 mmAq, 80 mmAq, 85 mmAq, or any value or range between the above values, but the present disclosure is not limited thereto.

As shown in FIG. 1, in some embodiments, the conversion component 30 may further include the reflow unit 32, and the reflow unit 32 is used to return the gas after passing through the conversion chamber 31 into the conversion chamber 31. For example, the reflow unit 32 may be a pump or other types of air extraction devices that is in fluid communication with the chamber air inlet 311 and the chamber air outlet 312 of the conversion chamber 31, but the present disclosure is not limited thereto. In some other embodiments, the reflow unit 32 may also be a flow guide pipe or a flow guide structure to transport the treated flue gas back to the conversion chamber 31 for additional processing.

In some embodiments, the flue gas may have a higher moisture content, or may condense due to the temperature drop during the conversion process. In this case, moisture may remain on the first catalyst structure 31S1 and the second catalyst structure 31S2 of the conversion chamber 31, causing the first catalyst structure 31S1 and the second catalyst structure 31S2 to be partially blocked or completely blocked. As a result, the conversion functions of the first catalyst structure 31S1 and the second catalyst structure 31S2 may be reduced or even disabled. Therefore, the reflow unit 32 may be disposed to return the treated flue gas (which has lower humidity than the untreated flue gas) into the conversion chamber 31 to take away the water adsorbed on the first catalyst structure 31S1 and the second catalyst structure 31S2. In this way, the partial blockage or complete blockage of the first catalyst structure 31S1 and the second catalyst structure 31S2 may be effectively alleviated. In some embodiments, the configuration with the reflow unit 32 may also be called an “online reflow design”.

In some embodiments, based on the total volume of flue gas flowing into the conversion chamber 31, the reflow unit 32 may extract at least 10% of the treated flue gas to return to the conversion chamber 31, but the present disclosure is not limited thereto. For example, the reflow unit 32 may extract 10%, 20%, 30%, 40%, 50%, 60%, 70%, or any value or range between the above values and return them into the conversion chamber 31.

As shown in FIG. 1, the scrubber component 40 is in fluid communication with the conversion component 30. In some embodiments, the conversion component 30 may convert nitrogen monoxide into oxygen, nitrogen, nitrogen dioxide, or a combination thereof, oxygen and nitrogen being the main components of the earth's atmosphere, wherein nitrogen dioxide is a pollutant found in trace amounts in the atmosphere. If inhaled, nitrogen dioxide may irritate the mucous membranes of the eyes, nose, throat, and respiratory tract. For example, exposure to low concentrations of nitrogen dioxide may cause bronchial allergies, or aggravate the reaction of asthma patients to allergens. Therefore, by providing a scrubber component 40, the nitrogen dioxide in the treated flue gas may be removed to further reduce the hazards of the treated flue gas. In some embodiments, the scrubber component 40 may be a gas scrubber for processing nitrogen dioxide, but the present disclosure is not limited thereto. In other embodiments, the scrubber component 40 may be a scrubber for simultaneously processing nitrogen dioxide and other gases (e.g., other nitrogen oxides).

As shown in FIG. 1, the air outlet 50 is in fluid communication with the scrubber component 40 to discharge the treated flue gas. In some embodiments, the air outlet 50 may be directly connected to the surrounding environment, for example, the treated flue gas may be directly discharged into the atmosphere, but the present disclosure is not limited thereto. In some embodiments, the air outlet 50 may also be in fluid communication with other gas remediation devices to perform other types of filtration.

As above-mentioned, based on some of the above configurations, the conversion efficiency of nitrogen monoxide of the gas remediation device 1 of the present disclosure is between 55% and 95%. For example, the conversion efficiency of nitrogen monoxide may be 55%, 60%, 70%, 75%, 80%, 85%, 90%, 95%, or any value or range between the above values. Some practical applications of the present disclosure are provided below for reference.

### Application Example 1

TABLE 1

| Type (size 50*50*50) | Flat | V, W or M Shape | H Shape |
|---|---|---|---|
| Degree of difficulty of | Simple | Complex | Simple |
| catalyst filling | | | |
| Contact area (cm²) | Small, | Large, | Large, |
| | 50 × | 43.5 × 50 × | 50 × 50 × |
| | 50 = 2500 | 2 = 4350 | 2 = 5000 |
| Surface speed (m/s) | 1.67 | 0.96 | 0.83 |
| (air flow = 25 m³/min) | | | |
| Pressure drop (Pa) | Large, 2573.2 | Medium, 1161.1 | Small, 643.3 |
| (air flow = 25 m³/min) | | | |
| NO concentration | 100 | Not tested | 100 |
| at air inlet 10 (ppm) | | | |
| NO concentration | 63 | Not tested | 39 |
| at outlet 50 (ppm) | | | |
| NO conversion rate | 37 | Not tested | 61 |
| (%) | | | |

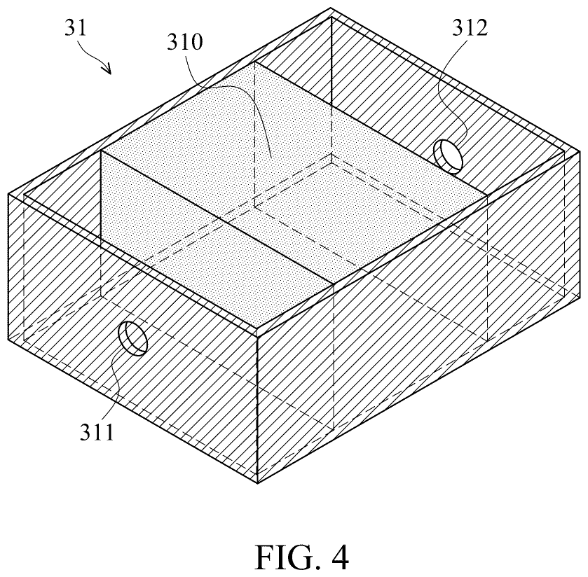

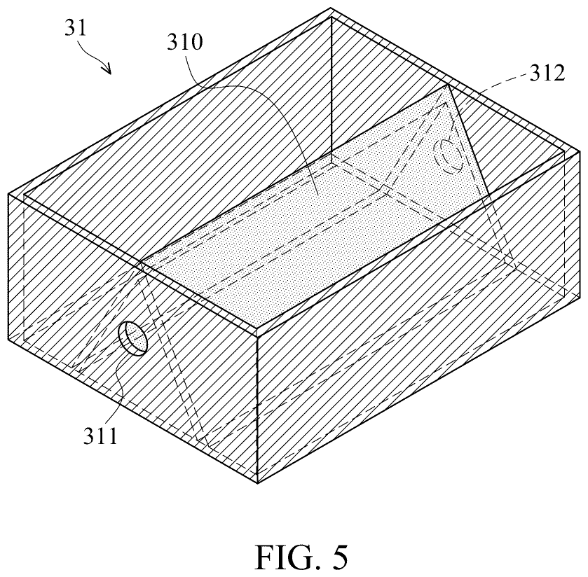

FIGS. 4 and 5 are respectively three-dimensional schematic diagrams of the conversion chamber according to other embodiments and further embodiments of the present disclosure. Among them, the conversion catalysts 310 in the conversion chamber 31 in FIG. 4 are arranged in a flat manner, while the conversion catalysts 310 in the conversion chamber 31 in FIG. 5 are arranged in a V shape. Compared with the embodiment in FIG. 2, with the same content of conversion catalyst, the use of H-shaped filling may effectively prevent the problem of excessive pressure drop. For example, the pressure drop of the flat structure (2573.2 Pa)>the pressure drop of the V-shaped structure (1161.1 Pa)>the pressure drop of the H-shaped structure (643.3 Pa). Furthermore, within the conversion chamber 31 of the same size, a higher conversion efficiency (for example, 61%) may also be achieved.

It should be noted that although the pressure drop of the H-shaped structure is lower, the present disclosure may still adopt the flat structure and the V-shaped structure according to actual needs. In other words, the pressure drop of the flue gas after passing through the conversion chamber (for example, including any one of these three catalyst structures) may be between 50 Pa and 2800 Pa. For example, the pressure drop of the flue gas after passing through the conversion chamber may be 50 Pa, 100 Pa, 150 Pa, 300 Pa, 400 Pa, 500 Pa, 600 Pa, 700 Pa, 800 Pa, 850 Pa, 1500 Pa, 2000 Pa, 2500 Pa, 2800 Pa, or any value or any range between the above values, but the present disclosure is not limited thereto.

Therefore, Table 1 shows that the H-shaped structure may have lower pressure drop and higher conversion efficiency than other structures. In the following, the conversion chamber 31 with the H-shaped structure is used as an example, and the experiment is carried out selectively with the reflow unit 32.

### Application Example 2

TABLE 2

| | Embodiment 1 | Embodiment 2 |
|---|---|---|
| Reaction temperature (° C.) | 28-30 | 28-30 |
| With or without reflow unit 32 | without | with |
| Reflow/inflow ratio | 0 | 0.5 |
| NO concentration at air inlet 10 (ppm) | 100 | 100 |
| NO concentration at air outlet 50 (ppm) | 39 | 25 |
| NO conversion rate (%) | 61 | 75 |
| Pressure drop (Pa) | 160 | 200 |

In Embodiment 1 and Embodiment 2, the conversion catalyst 310 is MnCe_{0.3}Co_{0.3}O_{z}, and the volume is 120 ml. The gas hourly space velocity (GHSV) is 3000 hr⁻¹. It may be known from Table 3 that without reflowing the treated flue gas (Embodiment 1), the gas remediation device 1 of the present disclosure has a conversion efficiency of at least 61%. In the case of reflowing 50% of the treated flue gas (i.e., reflow/inflow ratio=0.5) (Embodiment 2), the gas remediation device 1 of the present disclosure has a conversion efficiency of at least 75%.

### Application Example 3

TABLE 3

| | Embodi- | Embodi- | Embodi- |
|---|---|---|---|
| | ment 3 | ment 4 | ment 5 |
| Reaction temperature (° C.) | 28-30 | 28-30 | 28-30 |
| With or without reflow unit 32 | without | with | with |
| NO concentration | 460 | 460 | 460 |
| at air inlet 10 (ppm) | | | |
| NO concentration at the reflow port | none | 240 | 150 |
| in the conversion chamber 31 (ppm) | | | |
| NO concentration | 189 | 120 | 78 |
| at air outlet 50 (ppm) | | | |
| NO conversion rate (%) | 59 | 74 | 83 |
| Pressure drop (Pa) | 160 | 200 | 250 |

In Embodiments 3 to 5, the conversion catalyst 310 is MnCe_{0.3}Co_{0.3} O_{z}, and the volume is 120 ml. The gas hourly space velocity (GHSV) is 3000 hr⁻¹. It may be known from Table 3 that without reflowing the treated flue gas (Embodiment 3), the gas remediation device 1 of the present disclosure has a conversion efficiency of at least 59% and a pressure drop of 160 Pa. In the case of reflowing the treated flue gas (Embodiment 4), the gas remediation device 1 of the present disclosure has a conversion efficiency of at least 74% and a pressure drop of 200 Pa. In the case of reflowing the treated flue gas (Embodiment 5), the gas remediation device 1 of the present disclosure has a conversion efficiency of at least 83% and a pressure drop of 250 Pa.

### Application Example 4

TABLE 4

| | Embodiment 6 | Embodiment 7 |
|---|---|---|
| Reaction temperature (° C.) | 90-100 | 180-200 |
| With or without reflow unit 32 | with | with |
| Reflow/inflow ratio | 0.5 | 0.5 |
| NO concentration at air inlet 10 (ppm) | 100 | 100 |
| NO concentration at air outlet 50 (ppm) | 20 | 3 |
| NO conversion rate (%) | 80 | 97 |
| Pressure drop (Pa) | 200 | 200 |

In Embodiments 6 and 7, the conversion catalyst 310 is MnCe_{0.3}Co_{0.3} O_{z}, and the volume is 120 ml. The gas hourly space velocity (GHSV) is 3000 hr⁻¹. It may be known from Table 4 that in the case when 50% of the treated flue gas is recirculated and the reaction temperature is 90-100° C. (Embodiment 6), the gas remediation device 1 of the present disclosure has a conversion efficiency of at least 80%. In the case when 50% of the treated flue gas is recirculated and the reaction temperature is 180-200° C. (Embodiment 7), the gas remediation device 1 of the present disclosure has a conversion efficiency of at least 97%.

In summary, the embodiments of the present disclosure provide a gas remediation device that may effectively convert nitrogen monoxide, thereby achieving excellent remediation effects.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

1. A gas remediation device, comprising:
an air inlet for receiving flue gas, wherein the flue gas comprises nitrogen monoxide;
a dust filter component, in fluid communication with the air inlet;
a conversion component, in fluid communication with the dust filter component, wherein the conversion component comprises a conversion chamber, and the conversion chamber comprises a conversion catalyst, wherein the conversion catalyst converts the nitrogen monoxide into nitrogen, oxygen, nitrogen dioxide, or a combination thereof at an operating temperature, and the operating temperature is between 15° C. to 300° C.;
a scrubber component, in fluid communication with the conversion component; and
an air outlet, in fluid communication with the scrubber component.

2. The gas remediation device as claimed in claim 1, wherein the operating temperature is less than 250° C.

3. The gas remediation device as claimed in claim 1, wherein the conversion chamber has a first sidewall and a second sidewall opposite to each other, the conversion chamber further has a third sidewall and a fourth sidewall between the first sidewall and the second sidewall, and the conversion chamber comprises:
a first catalyst structure, adjacent to the first sidewall and extending along the first sidewall, wherein the first catalyst structure is filled with the conversion catalyst, and a first flow channel is formed between the first catalyst structure and the first sidewall;
a second catalyst structure, adjacent to the second sidewall and extending along the second sidewall, wherein the second catalyst structure is filled with the conversion catalyst, a second flow channel is formed between the second catalyst structure and the second sidewall, and a third flow channel is formed between the second catalyst structure and the first catalyst structure;
a barrier structure, disposed between the first catalyst structure and the second catalyst structure to divide the third flow channel into a first sub flow channel and a second sub flow channel;
a chamber air inlet, disposed on the third sidewall and in fluid communication with the first sub flow channel; and
a chamber air outlet, disposed on the fourth sidewall and in fluid communication with the second sub flow channel.

4. The gas remediation device as claimed in claim 3, wherein the first flow channel has a first width, the second flow channel has a second width, the third flow channel has a third width, and the third width is equal to a sum of the first width and the second width.

5. The gas remediation device as claimed in claim 3, wherein the conversion chamber has a length, a width, and a height, and a ratio of length to width to height of the conversion chamber is 2:1:2.

6. The gas remediation device as claimed in claim 3 wherein the first catalyst structure has a length, a width, and a height, and a ratio of length to width to height of the first catalyst structure is 100:8:100.

7. The gas remediation device as claimed in claim 3 wherein the second catalyst structure has a length, a width, and a height, and a ratio of length to width to height of the second catalyst structure is 100:8:100.

8. The gas remediation device as claimed in claim 3, wherein the first sub flow channel has a first length, the second sub flow channel has a second length, and the first length is the same as the second length.

9. The gas remediation device as claimed in claim 3, wherein the first catalyst structure has a first volume, the second catalyst structure has a second volume, and a sum of the first volume and the second volume occupies between 20% to 40% of a volume of the conversion chamber.

10. The gas remediation device as claimed in claim 3, wherein a pressure drop of the conversion chamber is between 50 Pa and 850 Pa.

11. The gas remediation device as claimed in claim 1, wherein the conversion component further comprises a reflow unit, and the reflow unit is used to return gas after passing through the conversion chamber into the conversion chamber.

12. The gas remediation device as claimed in claim 11, wherein the reflow unit extracts at least 10% of the gas after passing through the conversion chamber into the conversion chamber.

13. The gas remediation device as claimed in claim 11, wherein the reflow unit extracts 10% to 70% of the gas after passing through the conversion chamber into the conversion chamber.

14. The gas remediation device as claimed in claim 11, wherein a reflow/inflow ratio of the conversion chamber is 0.5.

15. The gas remediation device as claimed in claim 1, wherein the conversion catalyst comprises MnM1ₓM2_{y}O_{z}, wherein M1 is La, Ce, Fe, or a combination thereof, and M2 is Cu, Co, Ni, or a combination thereof, x is between 0.1 and 1, y is between 0.05 and 0.8, z is stoichiometric, and x>y.

16. The gas remediation device as claimed in claim 15, wherein the conversion catalyst is MnCe_{0.3}Co_{0.3}O_{z}.

17. The gas remediation device as claimed in claim 1, wherein the gas remediation device does not comprise an amino reducing agent.

18. The gas remediation device as claimed in claim 1, wherein a conversion efficiency of nitrogen monoxide of the gas remediation device is between 55% and 95%.

19. The gas remediation device as claimed in claim 1, wherein a material of the dust filter component comprises aluminum oxide (Al₂O₃) fiber, polytetrafluoroethylene (PTFE) fiber, polyimide (PI) fiber, aramid fiber, polyphenylene sulfide (PPS) fiber, or a combination thereof.

20. The gas remediation device as claimed in claim 1, wherein the scrubber component comprises a gas scrubber for processing nitrogen dioxide.

21. The gas remediation device as claimed in claim 1, wherein the barrier structure, the first catalyst structure and the second catalyst structure are arranged in an H shape.

22. A gas remediation device, comprising:
an air inlet for receiving flue gas, wherein the flue gas comprises nitrogen monoxide;
a dust filter component, in fluid communication with the air inlet;
a conversion component, in fluid communication with the dust filter component, wherein the conversion component comprises a conversion chamber, and the conversion chamber comprises a conversion catalyst, and wherein the conversion catalyst converts the nitrogen monoxide into nitrogen, oxygen, nitrogen dioxide, or a combination thereof at an operating temperature, and the operating temperature is between 15° C. to 300° C.; and
an air outlet, in fluid communication with the conversion component,
wherein the conversion chamber comprises at least one catalyst structure disposed therein and at least one flow channel defined by the at least one catalyst structure, and the conversion chamber is configured in such a manner that the flue gas entering the conversion chamber is forced to pass the same at least one catalyst structure at least twice from two opposite surfaces of the at least one catalyst structure respectively before exiting the conversion chamber.

23. The gas remediation device as claimed in claim 22, wherein the conversion chamber further comprises a barrier structure disposed therein, and the barrier structure is positioned perpendicularly to said two opposite surfaces of the at least one catalyst structure.

24. The gas remediation device as claimed in claim 22, wherein the conversion chamber further comprises a first sidewall having an air inlet, a second sidewall having an air outlet, a third longitudinal sidewall and a fourth longitudinal sidewall disposed between the first and second sidewalls,
wherein the at least one catalyst structure includes a first catalyst structure and a second catalyst structure, and
wherein the barrier structure is disposed between the first catalyst structure and the second catalyst structure, parallel with the first sidewall and second sidewall, and directly overlaps with the air inlet and the air outlet in the longitudinal direction.
